(19) United States
(12) Patent Application Publication
(10) Pub. No.: US 2011/0170294 A1
(43) Pub. Date: Jul. 14, 2011

(54) Modular Luminaire

(75) Inventors: Alejandro MIER-LANGNER, Providence, RI (US); Mohamed Aslam Khazi, West Bloomfield, MI (US)

(73) Assignee: Koninklijke Philips Electronics N.V., Eindhoven (NL)

(21) Appl. No.: 12/685,428

(22) Filed: Jan. 11, 2010

(51) Int. Cl. F21V 29/00

(52) U.S. Cl. 362/294; 362/373

(57) ABSTRACT

A modular luminaire comprises a luminaire base having a heat sink and a primary LED module, one of a plurality of interchangeable decorative elements disposed against the luminaire base, the plurality of decorative elements having a central aperture for light output, one of a plurality of interchangeable collar assemblies connected to the base and compressing the one of a plurality of decorative elements, the collar having a central collar aperture coaxial with the central opening of any of the decorative elements.

### CROSS-REFERENCE TO RELATED DOCUMENTS

None

### TECHNICAL FIELD

This invention pertains to a modular LED luminaire. More specifically, the invention pertains to a modular LED luminaire capable of varying appearance by interchanging of the decorative element and/or a collar.

### BACKGROUND

Recessed luminaires are extremely popular for a variety of reasons. In some instances however, recessed luminaires may not be utilized due to environmental conditions in the area of the ceiling where the luminaire is to be positioned. For example, a recessed luminaire may not be utilized where a joist is positioned in the ceiling or where plenum is too small to allow positioning of the luminaire fixture elements. Alternatively, a recessed luminaire may not be

Additionally, it is desirable to utilize lighting components which may be interchangeable by merely changing one or two elements in order to change the appearance of the light without necessitating removal of the entire fixture and replacement thereof. Such interchangeability allows the end user increased options in changing the appearance of the room and lighting therein without requiring changing of the entire fixture.

It is desirable to overcome these and other deficiencies in order to provide a light which has a similar appearance and light output to a recessed luminaire, while also allowing interchangeability of one or more components in order to change the appearance of the light output there from.

### SUMMARY

A modular luminaire comprises a luminaire base having a heat sink and a primary LED module, one of a plurality of interchangeable decorative elements disposed against the luminaire base, the plurality of decorative elements having a central aperture for light output, one of a plurality of interchangeable collar assemblies connected to the base and compressing the one of a plurality of decorative elements, the collar having a central collar aperture coaxial with the central opening of any of the decorative elements. The modular luminaire wherein the plurality of decorative elements is three elements. The modular luminaire wherein the plurality of decorative elements each has differing depths. The modular luminaire wherein the luminaire base has a depending threaded wall. The modular luminaire further comprising a threaded portion of the collar engaging the threaded wall of the luminaire base. The modular luminaire wherein the depending threaded wall having a thread on a radially inward facing surface. The modular luminaire wherein the collar has a thread on a radially outward facing surface. The modular luminaire wherein the decorative element is captured between an upper surface of a flange of the threaded collar and the luminaire base. The modular luminaire further comprising a reflector positioned within the threaded collar. The modular luminaire further comprising a lens over the LED module. The modular luminaire further comprising a secondary LED module for effect lighting.

A modular luminaire comprises a luminaire base, a heat sink disposed adjacent to the base and a primary LED array in thermal communication with the heat sink, a light mixing chamber extending below the primary LED array, a lens disposed within the lens frame, a connection wall depending from the luminaire base, a collar connected to the connection wall, the collar having a flange extending about a lower end of the collar, the collar capturing one of a plurality of decorative elements between the luminaire base and the flange. The modular luminaire wherein the threaded wall depends from the luminaire base. The modular luminaire wherein the threaded collar and the decorative element opening each having co-axial central apertures. The modular luminaire wherein the threaded collar is disposed radially inwardly of the decorative element. The modular luminaire further comprising a secondary LED array disposed against the luminaire base. The modular luminaire wherein the luminaire base has a locating rib to properly position the decorative element on the base. The modular luminaire wherein the plurality of decorative elements have different depths.

A modular luminaire comprises a lower collar flange, a decorative element seated on the lower collar flange and extending around a collar, a base having a plurality of LEDs and a heat sink positioned adjacent the plurality of LEDs, the plurality of LEDs positioned centrally within an opening of the decorative element, the collar connected to the base, the lower collar flange extending from the collar, the collar compressing the decorative element against the base. The modular luminaire wherein the decorative element is distinct from the collar. The modular luminaire wherein the decorative element is integral with the collar. The modular luminaire further comprising a plurality of secondary LEDs.

### BRIEF DESCRIPTION OF THE ILLUSTRATIONS

Embodiments of the invention are illustrated in the following illustrations.

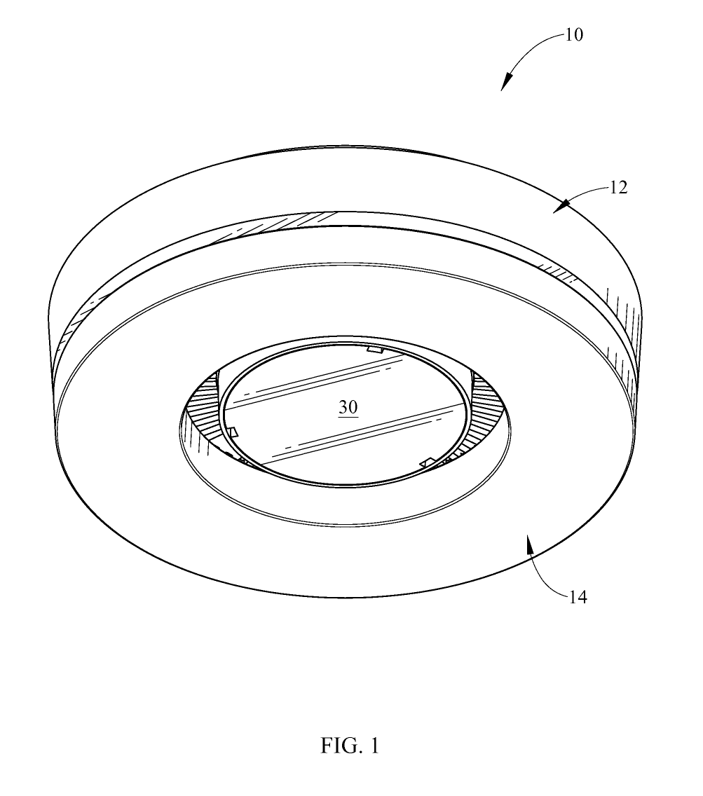

FIG. 1 depicts a perspective view of a first exemplary embodiment of a LED luminaire;

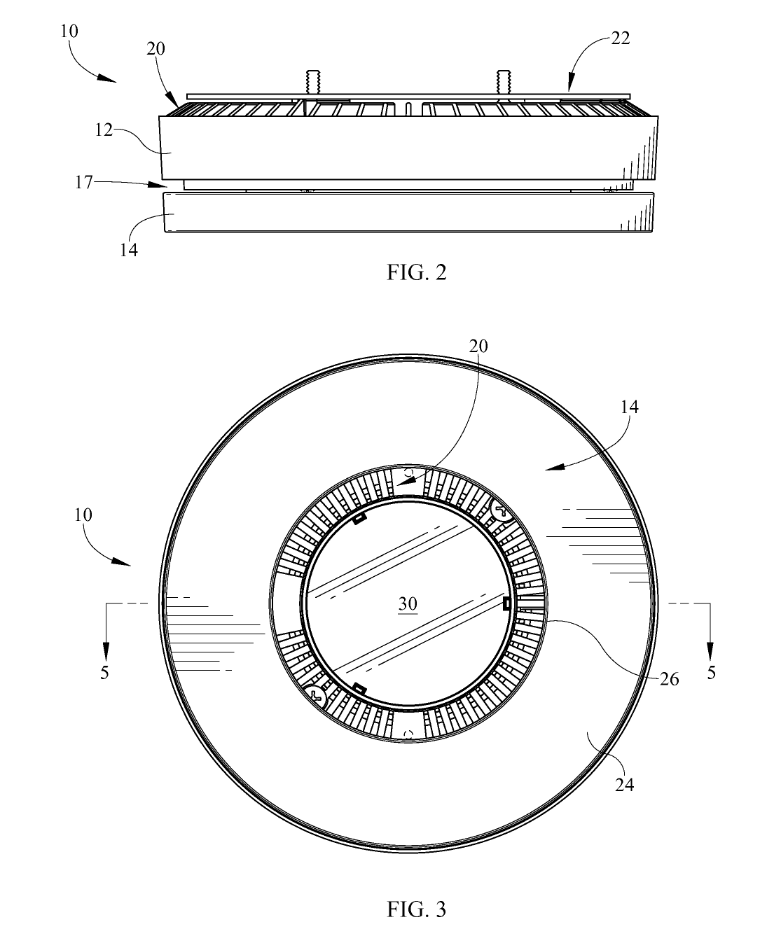

FIG. 2 depicts a side view of the modular LED luminaire of FIG. 1;

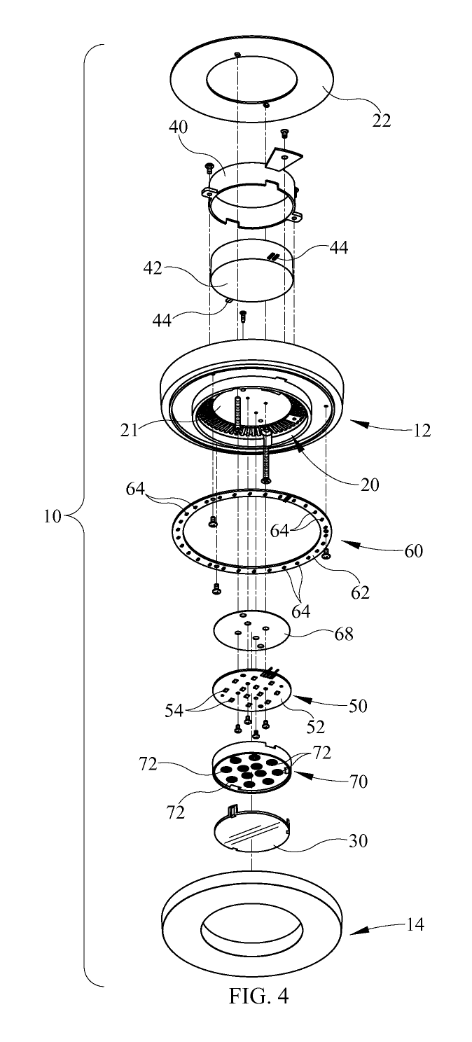

FIG. 3 depicts a bottom view of the modular LED luminaire of FIG. 1;

FIG. 4 depicts an exploded perspective view of the modular LED luminaire of FIG. 1;

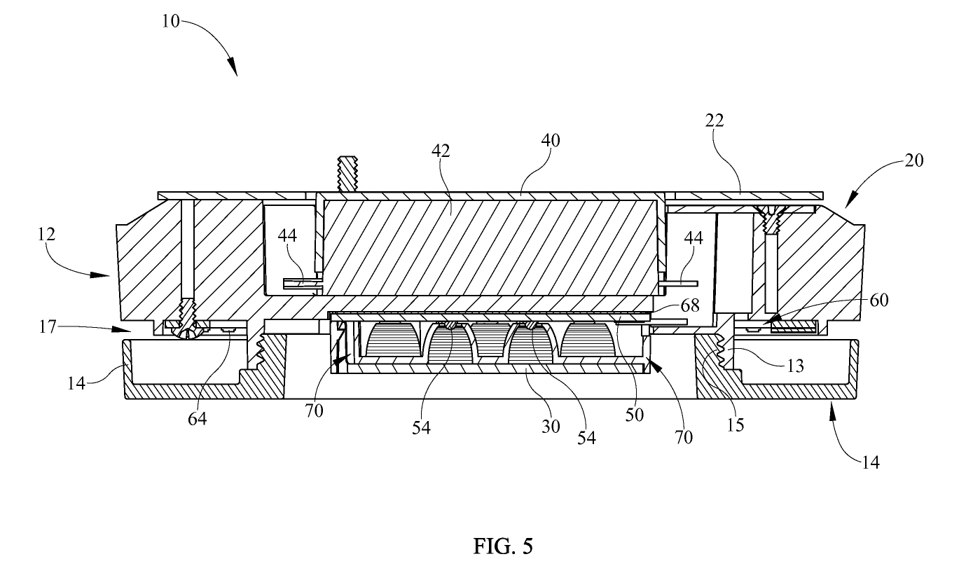

FIG. 5 depicts a side-section view of the modular LED luminaire of FIG. 1;

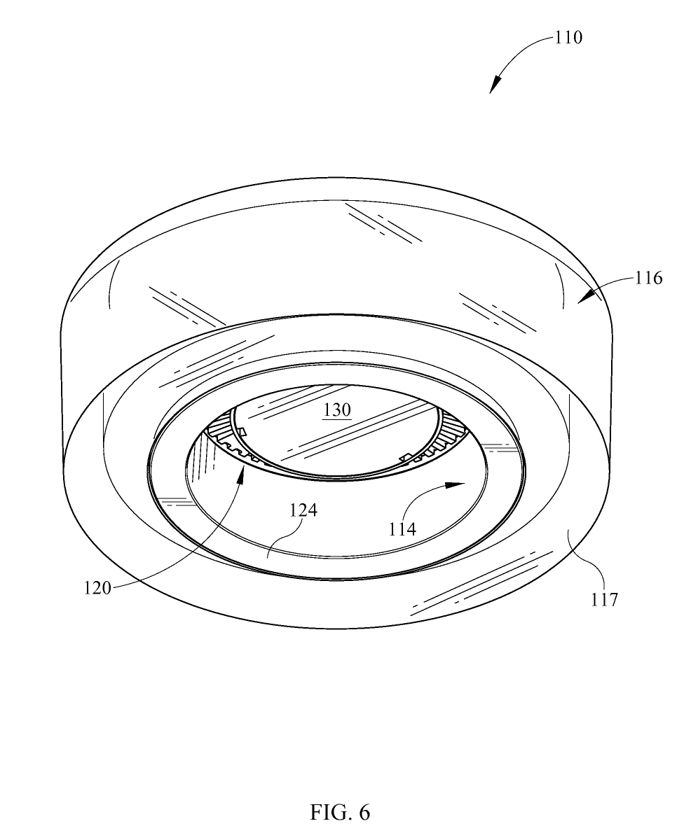

FIG. 6 depicts a perspective view of a second exemplary embodiment of a modular LED luminaire;

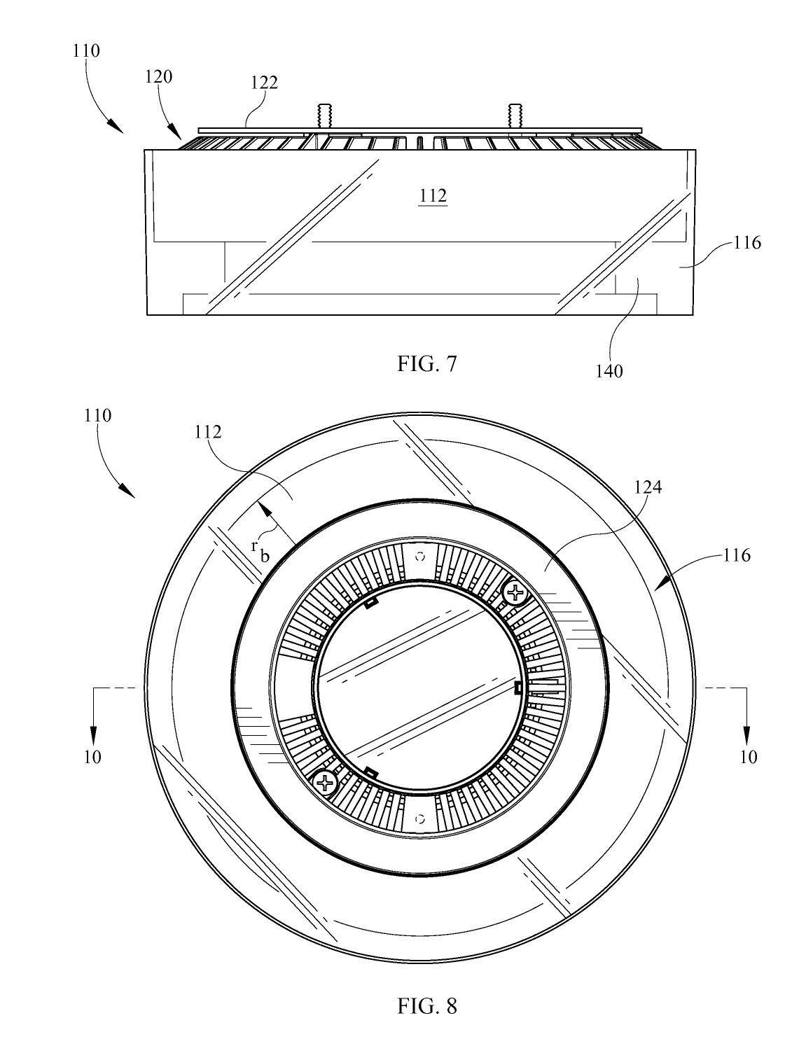

FIG. 7 depicts a side view of the modular LED luminaire of FIG. 6;

FIG. 8 depicts a bottom view of the modular LED luminaire of FIG. 6;

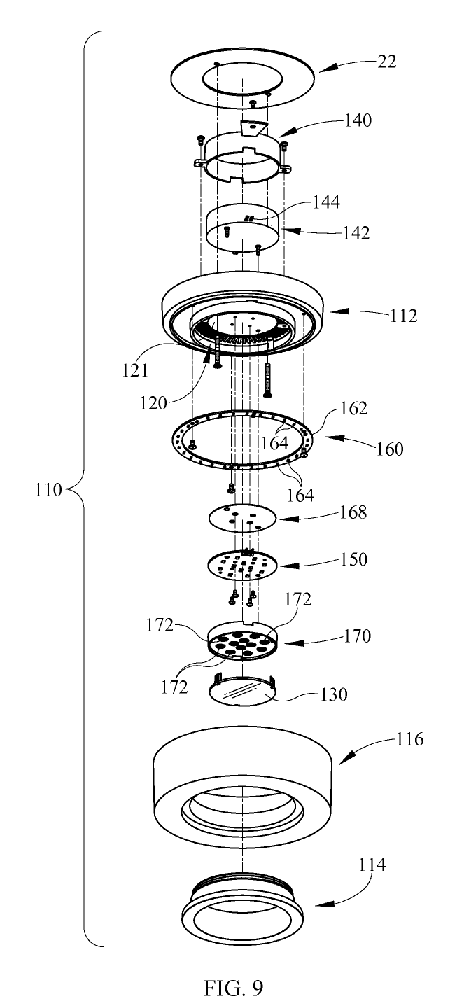

FIG. 9 depicts an exploded perspective view of the modular LED luminaire of FIG. 6;

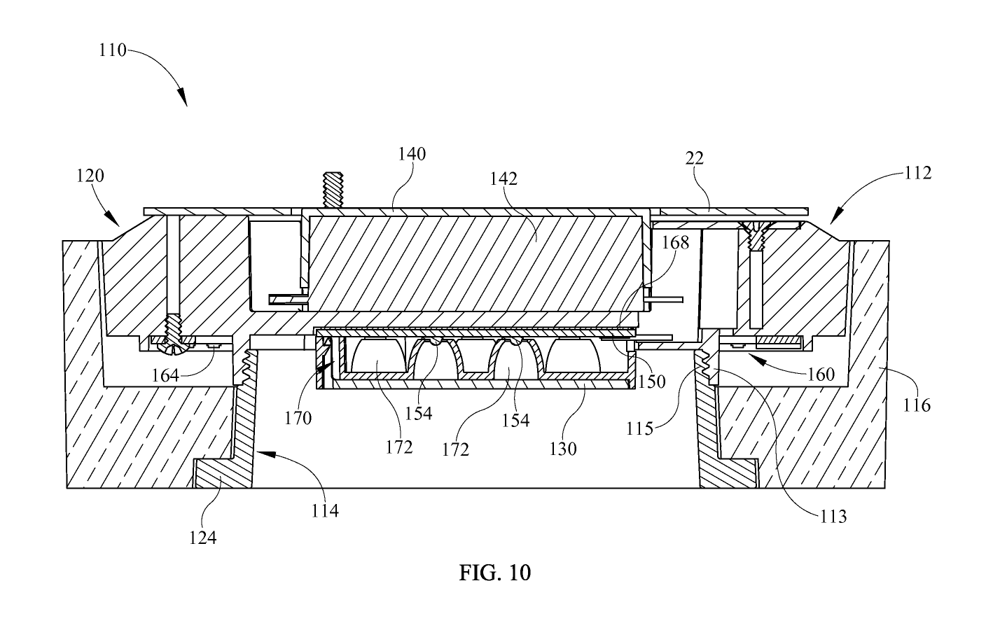

FIG. 10 depicts a side-section view of the modular LED luminaire of FIG. 6;

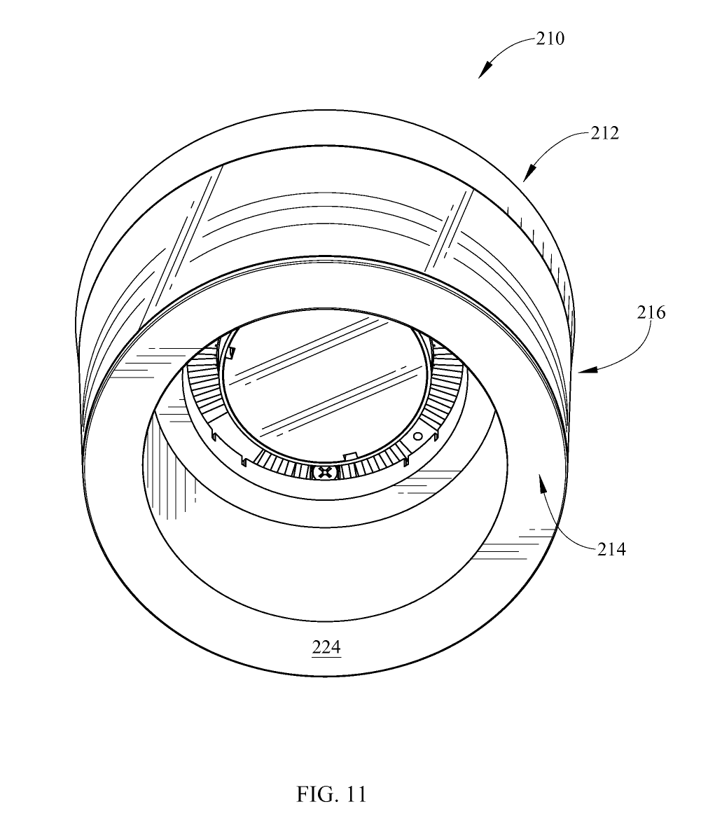

FIG. 11 depicts a perspective view of a third exemplary embodiment of the modular LED luminaire;

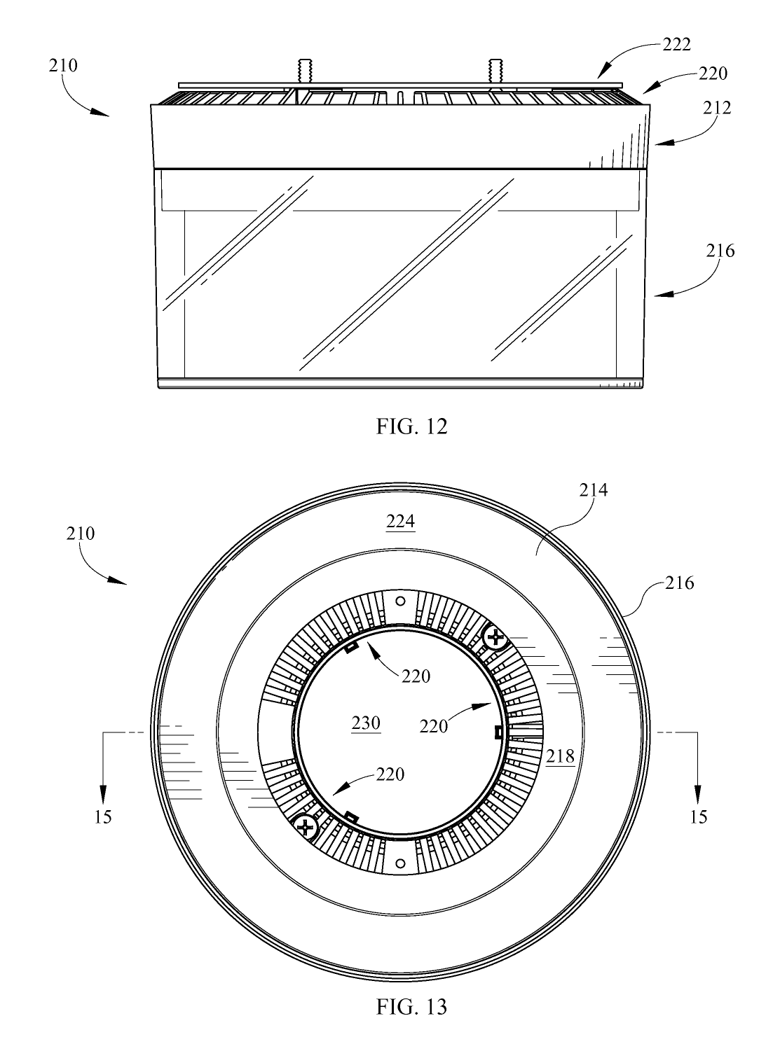

FIG. 12 depicts a side view of the modular LED luminaire of FIG. 11;

FIG. 13 depicts a bottom view of the modular LED luminaire of FIG. 11;

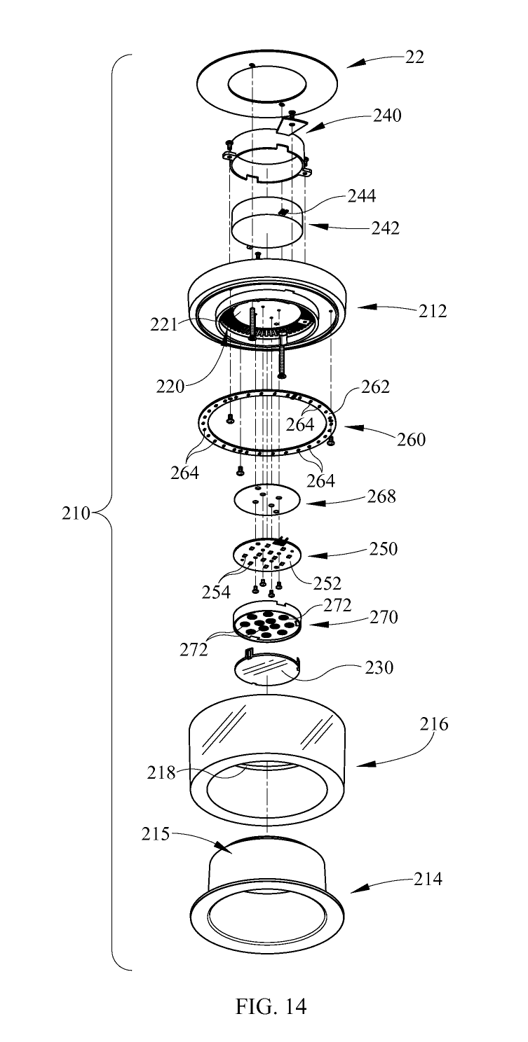

FIG. 14 depicts an exploded perspective view of the modular LED luminaire of FIG. 11; and,

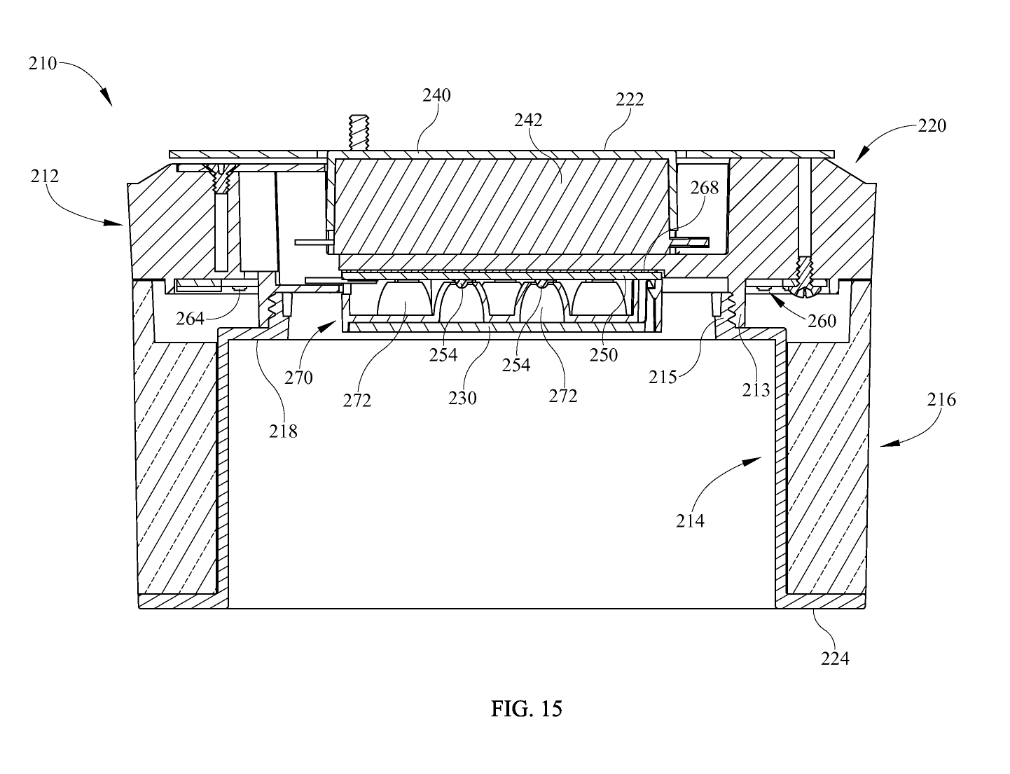

FIG. 15 depicts a side section view of the modular LED luminaire of FIG. 11.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

A modular light emitting diode (LED), luminaire is shown in the various FIGS. 1-15. The modular LED luminaire utilizes a modular design wherein a single base may be utilized and combined with various interchangeable decorative elements and one or more interchangeable collars to provide a light fixture capable of various appearances. Additionally, the modular luminaire may be positioned on a ceiling surface and provide a comparable light output and a similar appearance to a partially recessed light.

Referring initially to FIG. 1, a first embodiment of a modular LED luminaire 10 is depicted in perspective view. The luminaire 10 may be recessed with a ceiling or wall as shown in the exemplary embodiments. The luminaire 10 includes a base 12, at least one collar 14 and at least one decorative element captured between the base 12 and the collar 14. The decorative element may be integral with the collar 14 as shown or may be a distinct element from the collar as in further embodiments. The luminaire 10 may utilize various decorative elements and collars which are interchangeable in order to provide different appearances for the luminaire 10 as will be described further herein. Additionally, although the term collar is utilized throughout this description, one skilled in the art should realize that where alternate non-circular shapes are utilized for the instant luminaire, the collar need not be circular and should not be limited to such definition. For example, where a square shaped luminaire is utilize the collar may also be square in shape.

Referring now to FIG. 2, a side view of the luminaire 10 is depicted. The side view depicts the base 12 and the collar 14 having slightly tapered sides so that the luminaire has a frusto-conical appearance. However, the frusto-conical design of the base 12 and the threaded collar 14 is merely exemplary and should not be considered limiting as a straight sidewall may be utilized or as a further alternative embodiment an opposite taper as well, for example. Extending from the upper portion of the base is a heat sink 20 which transfers the heat from the LED lamps within the luminaire 10 out of the fixture and to ambient atmosphere in order to reduce the operating temperature of the LED lamps. The heat sink 20 is defined by a plurality of die cast aluminum fins which may or may not be integrally formed with base 12. An upper cover with plate 22 extends across a portion of the heat sink 20 in order to protect the inner elements of the luminaire 10 from contaminants. Additionally, due to the convective movement of air upward through the luminaire 10, the upper plate 22 limits the amount of contaminants which would otherwise be dispersed on the ceiling surface and which would be aesthetically unpleasing.

As shown also in FIG. 2, a gap 17 is defined between the collar 14 and the base portion 10. The gap 17 is visible due to the lack of a distinct decorative element in the first embodiment and as opposed to the subsequent embodiments. The gap 17 also functions as a secondary light output for LEDs positioned within the base 12 and radially outward of lens 30 (FIG. 3). The secondary LEDs provide a halo effect, or effect lighting which may include alternate shapes, about the luminaire 10 through the gap 17. According to the instant embodiment, the collar 14 is formed of a polished metallic material and the base 12 is also found with a metallic material so that the collar 14 functions as an integrated decorative element when the collar 14 and base 12 are threadably or otherwise connected. Additionally, the exemplary threaded connection between base 12 and collar 14 is not visible to a person passing beneath the down light luminaire 10 as viewed in FIG. 3. The depth of luminaire 10 is more shallow than subsequent embodiments as viewed from the upper plate 22 the lower flange surface 24 of the collar 14. The connection between the collar 14 and the base 12 is a threaded connection, however such connection is merely exemplary and various other mechanisms may be utilized to connect the base 12 and collar 14. The connection is hidden to improve the aesthetic appearance of the luminaire 10. Additionally, the collar and decorative element are shown as being circular in cross-section. However, alternative shapes may be utilized. For example, the luminaire 10 may have a square or rectangular shape.

Referring now to FIG. 3, the base 12 and the collar 14 of the first embodiment are both formed of metallic material. Accordingly, the base 12 may be formed of a polished aluminum or other polished, highly reflective material providing an aesthetically pleasing appearance. The collar 14 has a wide flange 24 and a radial inner edge 26 defining an opening through which light output from the LED lamps passes. Additionally, the heat sinks 20 are shown extending about the lamp socket region, as indicated by lens 30, and aid heat transfer to atmosphere.

The luminaire 10 may further comprise a lens 30 positioned within the base 12 and beneath the central LED lamps. The lens 30 may be formed of polycarbonate or acrylic and may provide an aesthetically pleasing color to the light output. The lens 30 also inhibits touching of or access to the lamps 54 as well as inhibiting contaminants from reaching the lamps 54.

Referring now to FIG. 4, an exploded perspective view of the luminaire 10 is depicted. The upper plate 22 is ring shaped and is positioned over a power supply cover 40 and power supply 42 therein. A plurality of leads 44 extend from the power supply 42 for electrical connection with primary and secondary LED boards 50, 60. The power supply 42 may be fastened or alternatively potted in the cover 40 to position therein and eliminate loosening or movement thereof.

Beneath the cover 40 is the base 12 which is, according to the exemplary embodiment, formed of die-cast aluminum. From the depicted view, the fins of the heat sink 20 are also shown. The heat sink 20 of the instant embodiment is integral with the base 12 and is also formed of die-cast aluminum although the heat sink 20 may be formed independently and later connected to the base 12. Within the central portion of the base 12 is thermal transfer surface 21.

Positioned on a lower surface of the base 12 and radially outward of the heat sink 20 is a secondary LED array 60. The secondary array 60 includes a circuit board 62 and a plurality of LED lamps 64. The circuit board 62 is ring shaped and includes a plurality of lamps 64 along the lower surface. The secondary LED array 60 is electrically connected to the power supply 42 to power the lamps 64. The secondary LED lamps 64 provide illumination from gap 17 (FIG. 2) to provide the previously described halo effect.

Beneath the LED array 60 is a thermal pad 68 which has an adhesive on an upper side. The thermal pad 68 is positioned on base surface 21 to eliminate gaps between the primary LED array 50 and the base 12. This, in turn, maximizes heat transfer from the LED array 50 to the heat sink 20. In short, any imperfections in the surface 21 or the LED array 50 are compensated for by the thermal pad 68. The LED array 50 is formed by an LED circuit board 52 and a plurality of LEDs 54 thereon. The LED array 50 is electrically connected to the power supply 42 allowing powering of the LED lamps 54.

Beneath the primary LED array 50 is a light mixing chamber 70. The chamber 70 is formed of a plurality of reflectors 72 which surround each of the LED lamps 54 and direct the light output downwardly and out of the chamber 70. The light mixing chamber 70 may also function to provide the appearance of a single light output rather than a plurality of single LED outputs.

Beneath the mixing chamber 70 is the lens 30 which is formed of acrylic or polycarbonate. The lens 30 may be tinted for a color effect if desired by the light designer. The lens 30 inhibits contact with the lamps 54 and prevents contaminants from reaching the lamps 54. Beneath the lens 30 is the threaded collar 14.

Referring now to FIG. 5, the luminaire 10 is shown in an assembled side-section view. The base 12 includes a depending connection wall 13 and a threaded portion on a radially inwardly facing surface. Although a threaded connection is shown, alternate mechanisms may be utilized to connect the base and 12 and collar 14. In the depicted embodiment, the collar 14 includes a threaded surface 15 which is radially outwardly facing. The threaded connection is therefore hidden from view from beneath the luminaire 10. The threaded surfaces may be reversed while keeping with the desired goal of inhibiting viewing of this threaded connection of the base 12 and collar 14. Also shown in FIG. 5 is the position of the second array 60 relative to the collar 14. The plurality of LEDs 64 on the second array 60 are directed downward to an upper surface of the collar 14. The light from the second array 60 is reflected upwardly and out of the luminaire through gap 17. This provides the previously described halo effect or effect lighting around the fixture, although the light halo need not be circular if an alternate shaped luminaire is utilized and therefore such term should not be considered limiting.

Referring now to FIG. 6, a perspective view of an alternate embodiment of a LED luminaire 110 is depicted. As shown in this embodiment, the luminaire 110 includes an at least semi-translucent decorative element 116 extending about the outer surface of the luminaire. Along a bottom or lower surface 117 is a collar 114. As in the previous embodiment, the collar 114 may be threaded, however alternate means of connection a base 112 and collar 114. As opposed to the threaded collar 14 of the previous embodiment, the collar 114 includes a lower flange 124 which is substantially more narrow than the flange 24 of the previous embodiment. The lower flange 124 provides a lower support for a distant decorative element 116, whereas the previous embodiment utilized a collar 14 which was a polished material and functioned additionally as an integrated decorative element. Within the opening of the collar 114 is a lens 130.

As previously described, the lens 130 may be formed of polycarbonate or acrylic and may or may not be tinted. Also shown spaced about the lens 130 are heat sink elements 120 which transfer thermal energy from the LED's to atmosphere and cause convection currents through the luminaire. As with the previous embodiment, the heat sink 120 is defined by a plurality of fins formed of die-cast aluminum.

Referring now to FIG. 7, a side view of the luminaire 110 is depicted. The side view of the luminaire 110 shows the heat sink 120 extending above the upper surface of the decorative element 116. First and second fasteners extend above the upper plate 122 for connection of the luminaire to the ceiling. As previously described, the instant embodiment may be flush mounted to a ceiling, although the fixture may alternatively be partially recessed if the ceiling and space above the luminaire allows for such mounting technique. According to the instant embodiment, the decorative element 116 is formed of an acrylic material which is also either translucent or semi-translucent and may or may not be tinted to a pre-selected color in order to add lighting effect to the light output. The at least semi-translucent decorative element 16 provides visual indication of the internal components within the luminaire 110. For example, the base 112 and collar 114 may be seen through the decorative element 116. The decorative element 116 extends from the upper edge of a base 112 downward to the lower edge of the luminaire. The decorative element 116 has a radially inwardly extending shoulder or ledge 140 which is seated upon an upper surface of the flange 124. In the view shown in FIG. 7, various lines are depicted in a distorted manner as would appear when viewed through the decorative element material 116. As one skilled in the art will understand, such distortion occurs when light passes from one medium such as air to a second medium, in this case the exemplary acrylic decorative material. For example, the vertical lines depicting the interface between the base 112 and the decorative element 116 shown closer to the outermost edges of the luminaire than this actual dimension due to the distortion which would be seen when looking at a side view of the luminaire 110.

Referring now to FIG. 8, a bottom view of a luminaire 110 is depicted. The translucent decorative element 116 is shown with an outer radial line indicating an outer edge of the base 112. The flange 124 is also shown, as well as the opening defined at the radially inner edge of the flange 124 so that light output from the LED lamps passes through the lower portion of the assembly.

Referring now to FIG. 9, an exploded perspective view of the luminaire 110 is depicted. At the top of the assembly is an upper plate 122 which is ring-shaped and positioned over a power supply cover 140. The cover 140 serves as a housing for a power supply 142. The power supply 142 includes leads 144 for electrical connection with at least one LED array. The power supply 142 is potted within the cover 140 to inhibit movement or loosing of one relative to the other. However, alternative means of connection may be utilized if desired.

Beneath the cover 140 and the power supply 142 is a base 112 which, according to the exemplary embodiment, is formed of die-cast aluminum. From the depicted view, the heat sink 120 is shown extending about the center portion of the base 112. As previously described, the base 112 is formed integrally with the heat sink 120, and therefore is also formed of die-cast aluminum, although the heat sink 120 may be formed independently of the base 112 and connected later in the manufacturing process. Also, within the central portion of the base 112 is a thermal transfer surface 121 which receives heat from at least one LED array and transfers the thermal energy to the heat sink 120. Although the base 112 is described with differing numbers than the first embodiment, it should be understood by one skilled in the art that the base 112 is the same as the base 12 and defines a structure from which various other interchangeable elements may be built upon in order to utilize a single fixture structure, yet provide various appearances for the fixture utilizing the decorative elements 116, 216 and collars 14, 114, 214.

Positioned beneath the base 112 and radially outward from the heat sink 120 is a secondary LED array 160. As previously described with the first embodiment, the secondary array 160 includes a circuit board 162 and a plurality of LED lamps 64 connected thereto. The circuit board 162 is generally ring-shaped and is electrically connected to the power supply 142 in order to power the LED lamps 164.

Beneath the LED array 160 is a thermal pad 168 having an adhesive on an upper side for adhering the pad 168 to the thermal transfer system 121. As previously indicated, the thermal pad illuminates gaps between the primary LED array 150 and the base 112 by compensating for imperfections in the surface 121 or the LED array 150. Such construction maximizes heat transfer between the components.

Beneath the thermal pad is the LED array 150 which is comprised of an LED circuit board 52 and a plurality of LEDs 154 thereon. The LED array 150 is electrically connected to the power supply 152, allowing powering of the LED lamps 154.

Beneath the primary LED array 150 is a light mixing chamber 170. The light mixing chamber comprises a plurality of reflectors which surround each of the LED lamps 154 and direct light output downwardly from the chamber 170. The light mixing chamber 170 provides the appearance of a single output rather than a plurality of single light outputs, thus mixing the light of the individual lamps 154.

Beneath the mixing chamber 170 is a lens 130 which may be formed of polycarbonate, acrylic or the like. The lens 130 is same structure as previously described. Likewise, the mixing chamber 170, LED array 150, thermal pad 168 and secondary LED array 160 are all the same structures as described in the first embodiment.

Beneath the lens 130 is the decorative element 116. As previously described, the decorative element 116 differs from the first embodiment which did not comprise a distinct decorative element. The decorative element 116 of the instant embodiment is formed of a polycarbonate, acrylic or the like, transparent, translucent, or at least semi-translucent, material allowing light to pass there from. The decorative element 116 has a central aperture through which light passes from the primary LED array 150. The secondary LED array 160 shines light outwardly and through the sidewalls of the decorative element 116.

Beneath the decorative element 116 is a threaded collar 114 which passes upwardly through the decorative element 116 and threadably fastens to the base 112.

Referring now to FIG. 10, a section view of the LED luminaire 110 is depicted. The base 112 includes the heat sinks 120 which extend from the inner surface of the decorative element 116 radially inward. The heat sink 120 is defined by a plurality of fins which are in thermal communication with the LEDs and circuit board operatively connected to the LEDs. The base 112 is connected to the collar 114 by a threaded portion 115 and a depending connection wall 113 having threads for threadable connection to the collar 114.

Referring now to FIG. 11, a third embodiment of the luminaire 210 is depicted in perspective view. The luminaire 210 differs from the first and second embodiments due to the deeper depth of the luminaire as measured from the top surface or plate of the fixture 210 to the lower most surface 224. According to this embodiment, the LED luminaire 210 includes a base portion, a decorative element 216 and a threaded collar 214. The luminaire 210 differs from the first and second embodiments additionally due to type of collar 214 utilized. For example, the collar 214 has a lower flange 224 which is positioned in a more radially outward location and the second embodiment of the LED luminaire 110. Additionally, the LED luminaire 210 differs from the first embodiment in that the luminaire utilizes separable or a distinct decorative element 216 formed of an acrylic, polycarbonate or like material which is transparent, translucent or at least semi-translucent. The base structure 212 may be the same as the base 12, 112 and the modular or interchangeable decorative element 216 may be utilized rather than the collar 14 alone for the decorative element 116 and collar 114 of the second embodiment. Thus, the luminaire is modular in the sense that it may have various appearances based on the user's desire by simply changing the decorative element and/or the collar structure. Additionally, the collar 214 may be a threaded collar but various other connection mechanisms may be utilized. Additionally, as with the first and second embodiments, the exemplary luminaire 210 is shown as having a round shape but various shapes may be utilized, such as square, rectangular or other polygons.

Referring now to FIG. 12, a side view of the luminaire 210 is depicted. The base portion 212 includes a heat sink 220 extending from an upper portion thereof and an upper plate 222 generally covering the uppermost edges of the heat sink 220. As previously described, the base 212 is the same as the first and second bases 12, 112. This allows for varied luminaire appearance by merely changing the decorative element and or threaded collar. As shown, the luminaire of FIG. 12 has a depth which is greater than the first and second embodiments of the luminaire. The increased depth is due to the depth of the collar 214 and decorative element 216.

Referring to FIG. 13, a bottom view of the luminaire 210 is depicted. The flange 224 is shown defining the lower portion of the collar 214. Radially inward of the flange 224 is a surface 218 which is vertically offset from the heat sink 220. The step surface 218 differs from the second embodiment of the decorative element 116.

Referring now to FIG. 14, an exploded perspective view of the luminaire 210 is depicted. The elements of the luminaire 210 are the same as previously described with numbers changed only to depict a differing embodiment. However, the decorative element 216 and collar 214 differ from the embodiments previously described. As shown, the decorative element 216 has a depth which is greater than the depth of the decorative element 116 and additionally includes a stepped-in area near an upper elevation of the decorative element 216.

As shown clearly in FIG. 15, the decorative element 216 is threadably connected to the base 212. Additionally, the side section view of FIG. 15 clearly depicts the stepped area 218 of the threaded collar of 214.

Accordingly, the base 12, 112, 212 may be utilized with various separable and distinct decorative elements 116, 216 as well as various threaded collars 14, 114, 214 which may or may not be integrated with the decorative finish in order to illuminate the need for a distinct decorative element.

The foregoing description of several embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A modular luminaire, comprising:
a luminaire base having a heat sink and a primary LED module;
one of a plurality of interchangeable decorative elements disposed against said luminaire base, said plurality of decorative elements having a central aperture for light output;
one of a plurality of interchangeable collar assemblies connected to said base and compressing said one of a plurality of decorative elements, said collar having a central collar aperture coaxial with said central opening of any of said decorative elements.

2. The modular luminaire of claim 1, said plurality of decorative elements being three elements.

3. The modular luminaire of claim 1, said plurality of decorative elements each having differing depths.

4. The modular luminaire of claim 1, said luminaire base having a depending threaded wall.

5. The modular luminaire of claim 4 further comprising a threaded portion of said collar engaging said threaded wall of said luminaire base.

6. The modular luminaire of claim 5, said depending threaded wall having a thread on a radially inward facing surface.

7. The modular luminaire of claim 6, said collar having a thread on a radially outward facing surface.

8. The modular luminaire of claim 1, said decorative element captured between an upper surface of a flange of said threaded collar and said luminaire base.

9. The modular luminaire of claim 1 further comprising a reflector positioned within said threaded collar.

10. The modular luminaire of claim 1 further comprising a lens over said LED module.

11. The modular luminaire of claim 1 further comprising a secondary LED module for effect lighting.

12. A modular luminaire, comprising:
a luminaire base;
a heat sink connected to said base and a primary LED array in thermal communication with said heat sink;
a light mixing chamber extending below said primary LED array, a lens disposed within said lens frame;
a connection wall depending from said luminaire base;
a collar connected to said connection wall, said collar having a flange extending about a lower end of said collar;
said collar capturing one of a plurality of decorative elements between said luminaire base and said flange.

13. The modular luminaire of claim 12, said threaded wall depending from said luminaire base.

14. The modular luminaire of claim 12, said threaded collar and said decorative element opening each having co-axial central apertures.

15. The modular luminaire of claim 14, said threaded collar disposed radially inwardly of said decorative element.

16. The modular luminaire of claim 12 further comprising a secondary LED array disposed against said luminaire base.

17. The modular luminaire of claim 12, said luminaire base having a locating rib to properly position said decorative element on said base.

18. The modular luminaire of claim 12, said plurality of decorative elements having different depths.

19. A modular luminaire, comprising:
a lower collar flange;
a decorative element seated on said lower collar flange and extending around a collar;
a base having a plurality of LEDs and a heat sink positioned adjacent said plurality of LEDs;
said plurality of LEDs positioned centrally within an opening of said decorative element;
said collar connected to said base, said lower collar flange extending from said collar;
said collar compressing said decorative element against said base.

20. The modular luminaire of claim 19 wherein said decorative element is distinct from distinct from said collar.

21. The modular luminaire of claim 19 wherein said decorative element is integral with said collar.

22. The modular luminaire of claim 19 further comprising a plurality of secondary LEDs.
